(19) United States
(12) Patent Application Publication
(10) Pub. No.: US 2011/0141107 A1
(43) Pub. Date: Jun. 16, 2011

(54) Method for Producing an Autostereoscopic Display and System for an Autostereoscopic Display

(75) Inventor: Dirk Stendel, Berlin (DE)

(73) Assignee: TECHNISCHE UNIVERSITAET BERLIN, Berlin (DE)

(21) Appl. No.: 12/994,652

(22) PCT Filed: May 25, 2009
(86) PCT No.: PCT/DE2009/000718

§ 371 Date: Feb. 16, 2011

(30) Foreign Application Priority Data
May 26, 2008 (DE) 102008025103.8
May 29, 2009 (WO) PCTDE2009000718

(51) Int. Cl. G06T 15/00

(52) U.S. Cl. 345/419

(57) ABSTRACT

The invention relates to a methods for producing an autostereoscopic display, that shows at least one object. An illustrative method in accordance with the invention comprises, with the help of a radiation image design in a virtual optical imaging system, comprising at least one object, an imaging lens that is disposed opposite the at least one object and images said object as an object image in an image plane, and a recording device recording the object image in the image plane, producing image data for a parallax panoramagram of the object image in the recording device, producing an image corresponding to the image data for the parallax panoramagram and producing an autostereoscopic display by disposing a transparent planar arrangement of imaging elements that corresponds to the imaging lens upstream of the parallax panoramagram.

The invention relates to a method for producing an autostereoscopic display and system for an autostereoscopic display.

### BACKGROUND OF THE INVENTION

Parallax panoramagrams, which are also used as base images for lenticular screen images, can spatially reproduce objects with optically active components placed directly upstream. The reproduced objects can then be observed with the human eye without additional aids. In these systems, for example, optically active components such as lenticular screens, which comprise a planar arrangement of multiple optical split lenses or split cylinders, are arranged in front of the parallax panoramagram of the object to be displayed. The parallax panoramagram is prepared in a particular manner for this purpose. In combination with the human visual apparatus, a spatial impression thus eventually appears. Lenticular screen arrangements or lenticular sheets consist for example of acrylic or polyethylene.

According to the prior art the displayed image of the object (parallax panoramagram) is created according to a so-called interlace method. In this method, multiple half images of the object are created, which involve in particular images of the object from different spatial positions, for example by photography or rendering, and then combined by processing. These multiple half images are separated into “thin strips”, for example by means of a suitable software application, and reassembled strip by strip. A complete set of strips of the half images applied is then located under each lens of the lenticular screen. This is usually transformed with the software application on a data processing device. The interlaced image produced in this way—which if there are two interlaced half images is termed a stereogram, or if more than two a parallax panoramagram—is then printed, in order to subsequently position the corresponding lens arrangement over it. The human visual apparatus perceives the lenticular screen image created as a spatial representation of the imaged object. Without the upstream lenticular screen the stereogram/parallax panoramagram appears blurred to the observer.

Bourke for example published in December 1999 a detailed description of the interlace method in his paper: “Autostereoscopic Lenticular Images” (http://local.wasp.uwa.edu.au/˜pbourke/projection/lenticular/).

Parallax panoramagrams or stereograms generated with the interlace method are subject to observational and manufacturing limitations. In connection with lenticular screen images the most severe limitation occurs with respect to the specified (optimal) observer position or the associated minimum observation distances, since otherwise the spatial image can optically decompose or the stereoscopic effect can even be reversed. Secondly, these 3D images are displayed with relatively low visual resolution, since due to limitations of the technology in the case of the lenticular screen image this resolution is essentially a result of the fineness of the half lenses (75 lpi≈75 dpi, lpi=lenses per inch). These can in turn, the smaller they are, only image three-dimensionality in a limited way For spatial simulations the half lenses or half cylinders of the lenticular screen sheet are constructed in such a way that their focal point is located exactly on the base of the lens. This also leads to unavoidable compromises in quality however that are inherent in the technology. Object contours are always displayed in a stepwise fashion in the horizontal direction. In the lenticular technology at least the result is always a detrimental decline in resolution between horizontal and vertical directions. But the change in the displayed image between the individual half-image strips, the so-called image flip, also constitutes a defect. Lenticular screen sheets for animation effects differ from this construction principle. The individual half lenses do not focus as sharply. This also reduces the decline in resolution within the lenticular screen image.

In order to generate 3D images also with animation lenses, base images conesponding to the imaging properties of the individual lenses are necessary. This means that the optical advantages of these lenses for these images can be exploited. These include for example a lower drop in resolution, lower material thickness of the lenticular screen sheets for example, increased dimensions of the individual lenses (up to approximately 1 cm wide≈2 lpi) and hence improved manufacturability and handling properties, improved adjustment of the individual components of an autostereoscopic image generated in this way.

Other methods for manufacturing parallax panoramagrams are known. These have mostly been developed in photography and are hardly used any longer today. The manufacture is accomplished by a complex and constantly repeated exposure of the image by means of, for example, a lenticular screen element placed immediately upstream of the photofilm. Using this technology it is usually possible only to simulate a spatial image in front of the so-called stereo window, this being the case both for lenticular as well as for integral images. In the latter, circular lens arrangements for example are used on the screen sheet. This considerably impairs the realistic and convincing effect of the stereoscopic image. Moreover, huge manufacturing costs are required relative to the interlace method. Its implementation normally requires a good deal of technical knowledge (cf. Roberts et al.: “The History of Integral Print Methods”; http://www.integralresource.org/Integral_History.pdf).

Further explanations on this topic can be found for example in Roberts et. al., “The History of Integral Print Methods” (http://www.microlens.com/pdfs/history_of_lenticular.pdf). Of particular interest to the new method described here is document WO 95/31795. The creation of an object depth-dependent parallax panoramagram using a calculation algorithm and virtual spatial computer data is described. This mechanism is very costly however in complex displays and for photorealistic displays for example, such as are used in particular to produce renderings, it is relatively poorly suited.

### DESCRIPTION OF THE INVENTION

The problem addressed by the invention is to create an improved method for producing an autostereoscopic display and an improved system for an autostereoscopic display, which simplify the provision of autostereoscopic images with optimised quality.

According to one aspect of the invention, a method for producing an autostereoscopic display which may also referred to as one of picture, image, and depiction is provided which shows at least one object, wherein in the method, by means of an application running on a data processing device for the at least one object, with the help of a radiation image design in a virtual optical imaging system, which comprises the at least one object, an imaging lens that is disposed opposite the at least one object and images said object as an object image in an image plane, and a recording device recording the object image in the image plane, image data is produced for a parallax panoramagram of the object image in the recording device, an image corresponding to the image data for the parallax panoramagram is produced and an autostereoscopic display is produced by disposing a transparent planar arrangement of imaging elements that corresponds to the imaging lens upstream of the parallax panoramagram.

According to a further aspect of the invention a system or arrangement with an autostereoscopic display is created, in which an image, which corresponds to image data of a parallax panoramagram for an object image, is applied on an imaging side of a carrier material and a transparent component is arranged upstream of the imaging side with a transparent planar arrangement of imaging elements, corresponding to an imaging lens, wherein by means of an application running on a data processing device for at least one object with the help of a radiation image design in a virtual optical imaging system, which comprises the at least one object, the imaging lens that is disposed opposite the at least one object and images said object as an object image in an image plane, and a recording device (8) recording the object image (6a, 6b) in the image plane, the image data for the parallax panoramagram of the object image in the recording device are generated in the recording device.

The invention comprises the idea of using the radiation image design in an optical imaging system during the production of the parallax panoramagram. The optical imaging system comprises the at least one object to be displayed and an imaging lens that is disposed opposite the at least one object and images said object as an object image in an image plane. The imaging lens is for example a planar lens arrangement, which can also be referred to as a lenticular screen, of an appropriate design. Furthermore the optical imaging system comprises a recording device, for example a camera, with which the object image generated in the image plane by means of a radiation image design is recorded, wherein the recorded image (parallax panoramagram) is also generated in the recording device by using the radiation image design.

The image data for the recorded image (parallax panoramagram) are then used to generate a corresponding image, either by means of an electronic image display, for example on a display, or by printing the image on to a carrier material. The autostereoscopic image or display then arises by disposing a lens corresponding to the imaging lens of the optical imaging system, for example designed as a planar lens arrangement, upstream of the image. In one configuration, in which the image corresponding to the image data of the recorded image (parallax panoramagram) is output via a display, the planar lens arrangement can also be generated on the display by means of electronic simulation, in order to thus create the spatial 3D impression for the human visual apparatus. When applying the image on to a carrier material, for example by printing, the planar lens arrangement, for example in the form of an appropriately configured, transparent, optically active component is placed upstream of the image.

In contrast to the prior art, in the proposed method, which can also be referred to as the VLR method (VLR—“Virtual Lenticular Rendering”), it is not necessary to first generate multiple images of the object to be displayed and then decompose them into strips, in order to then recombine them according to a pre-defined order. Rather, by using the radiation image design corresponding to the parameters of the optical imaging system the recorded image (parallax panoramagram) is generated directly in the recording device, which is in turn derived by means of the radiation image design from the object image in the image plane.

According to a further aspect of the invention a method for producing an autostereoscopic display is created, which shows at least one object, wherein the method uses an interlace method and wherein the strips interlaced together in the interlace method comprise strips of different width. The width of the strips is derived directly from the optical properties of the arrangement of imaging elements subsequently placed downstream. In doing so both the individual imaging element as well as its position in the overall arrangement of the imaging elements can be taken into account.

A further aspect of the invention provides a method for producing an autostereoscopic display, which shows at least one object, wherein the method uses an interlace method and wherein distances between recording positions for a recording device, with which as part of the interlace method images of the at least one object are generated, comprise differing, non-equidistant intervals. These variable distances are derived from the optical properties of the arrangement of imaging elements subsequently placed upstream. In doing so the alignment can be converted from the percentage of imaging exposure, for example of a half lens of a lenticular screen sheet, directly into recording device intervals.

With the aid of the different aspects of the invention it becomes possible to better take into account, in different ways, the specific surface construction and the optical properties of the arrangement of imaging elements in which a lenticular screen sheet is involved in a preferred embodiment, in order thus to optimise the quality of autostereoscopic images. To this extent the various aspects of the invention form different solution options for the problem addressed here.

In the following, advantageous configurations of the aspects of the method for producing autostereoscopic images are described.

A preferred embodiment of the invention provides that the autostereoscopic display is generated by displaying the image data for the parallax panoramagram via a display area and the arrangement of imaging elements upstream of the imaging lens is displayed on the display area in the form of an electronically simulated arrangement of imaging elements. In this manner autostereoscopic displays can be generated on any desired display devices.

In an expedient embodiment of the invention it can be provided that the autostereoscopic display is generated by generating the image corresponding to the image data for the parallax panoramagram on a carrier material on an imaging side and a transparent component with the arrangement of imaging elements being arranged upstream of the imaging side. For the arrangement of imaging elements, standard commercial lenticular screen sheets can for example be used, which are known as such in different variants. For example, such lenticular screen sheets are available in acrylate or polyethylene.

An advantageous embodiment of the invention provides that the imaging and optically active component is specifically adapted depending on the at least one object (scenery), in particular by having a variable size for the individual elements. Due to a close coupling between the spatial image depth that can be imaged, lens surface and lens size, by separately adapting each individual element of a screen sheet the image properties can be enhanced. A lenticular screen sheet for example could then, optimised by different half lens sizes, reproduce autostereoscopic displays, object-specifically and scene-specifically.

An advantageous embodiment of the invention provides that the parallax panoramagram be printed on to the carrier material. The printing is carried out on to photo paper by means of a printer, for example.

An embodiment of the invention provides that the transparent component is adhesively disposed on the imaging side. This involves an adhesive connection being established between the carrier material and the transparent component by using a suitable adhesive agent, for example a transparent glue.

In an advantageous embodiment of the invention it can be provided that when generating the image data for the object image the radiation image design in the virtual imaging system is designed so as to use a refractive index that is not equal to 1.

An embodiment of the invention can provide that lenses of the arrangement of imaging elements are shaped such that on a side facing away from the image they comprise a curved surface, and on a side facing the image side an essentially flat surface. In one configuration of the VLR method, when determining the image data per image element the surface of the virtual arrangement of imaging element is arranged to be mirror-inverted with respect to the imaging lens of the mounted transparent component.

One preferred embodiment of the invention provides that autostereoscopic display data are stored on an electronic storage medium, which data comprise the image data for the parallax panoramagram and information about parameters for the imaging lens. The parallax panoramagram data can then be read and processed by means of a suitable software application from the electronic storage medium, which is for example a CDROM, a DVD or a memory stick, in order to generate the desired autostereoscopic image of the object on a display device. The image data, including the electronic information about the lens arrangement, can be regarded as a kind of coded display for the image of the object.

### BRIEF DESCRIPTION OF THE DRAWINGS

The invention is described in greater detail in the following, with the aid of exemplary embodiments and by reference to figures. They show:

FIG. 1 a schematic illustration of a lens from a planar lens arrangement (10 lpi, animation lens),

FIG. 2 a schematic illustration of a section of a planar lens arrangement with imaging rays,

FIG. 3 a further schematic illustration of a section of a planar lens arrangement with imaging rays,

FIG. 4 a schematic illustration of a planar lens arrangement,

FIG. 5 a schematic illustration of an optical imaging system with an imaging lens constructed as a planar lens arrangement,

FIG. 6 a schematic illustration of an object image in an image plane,

FIG. 7 a schematic illustration for comparing the method for producing a lenticular screen base image (parallax panoramagram) with the observation of the generated lenticular image with the human visual apparatus,

FIG. 8 a schematic illustration of an optical imaging system during the generation of a lenticular screen base image of four cubes,

FIG. 9A to 9D image displays, generated by radiation image design for the four cubes of FIG. 8 without a planar lens arrangement (FIG. 9A) and with a planar lens arrangement using refractive indices of 0.97 (FIG. 8B), 0.93 (FIG. 5C) and 0.87 (FIG. 5D),

FIG. 10 diagram showing the size of an imaging region under a half lens of a lenticular screen as a function of the viewing angle,

FIG. 11a schematic illustration with an object to be imaged and multiple recording positions,

FIG. 12 half-image superposition of half images from FIG. 11,

FIG. 13a schematic illustration to explain an interlacing of strip elements in an adapted interlace method with variable strip widths,

FIG. 14a schematic illustration with an object to be imaged and multiple non-equidistant recording positions,

FIG. 15 half-image superposition of half images according to the arrangement in FIGS. 14, and

FIG. 16a schematic illustration to explain the interlace method using half images, which have been produced by non-equidistant recording positions, and

FIG. 17 comparison of embodiments for the improvement of autostereoscopic images.

FIG. 18A to 18C image displays which were generated by radiation image design for a cube of FIG. 8 with planar lens arrangement, firstly with circular individual elements using refractive indices of 0.9 (FIG. 18A) and 0.95 (FIG. 18B), and using a non-circular lens surface (two crossed lenticular screen sheets each with equal-sized half lenses) and the refractive index of 0.9 (FIG. 18C), and

FIG. 19 image display which shows an image of a cube generated by means of a radiation image design, which was created specifically on the basis of an available shaped glass sheet.

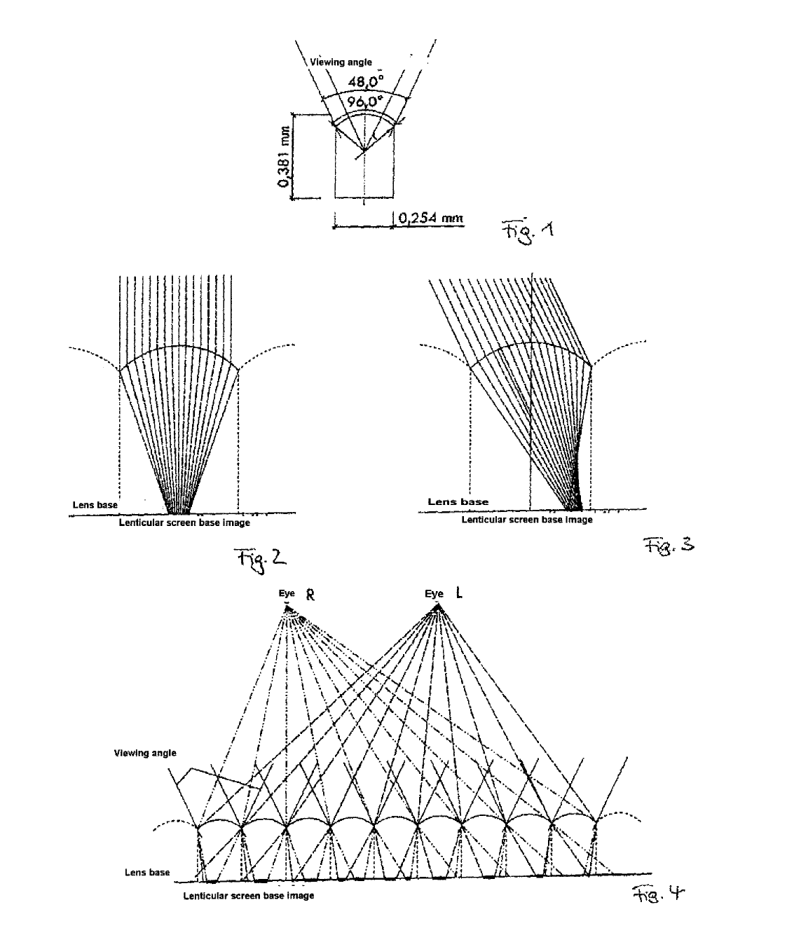

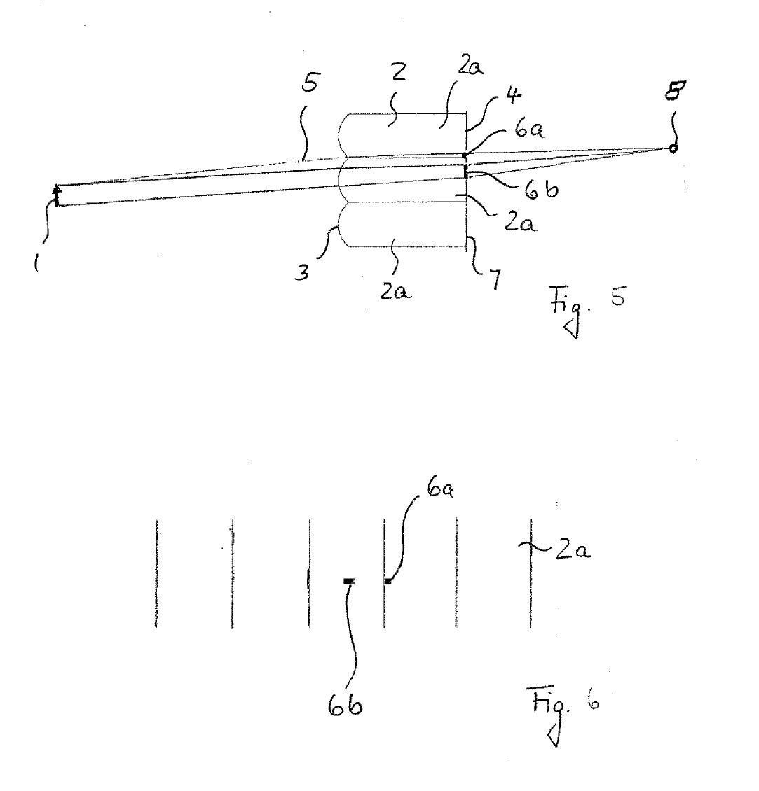

FIG. 1 shows a schematic illustration of a lens 2a, as is used in the planar lens arrangement 2. It turns out that an imaging region in the lens 2a constantly changes according to the viewing angle. In particular the imaging region is largest in the centre of a lens base (FIG. 2, viewing angle=0°) and decreases towards the edges of the lens (FIG. 3, viewing angle=24°). Position and dimensions of the imaging regions therefore change in an interrelated manner according to the viewing angle. FIG. 4 shows this continuous change as viewed from above using a lenticular screen sheet.

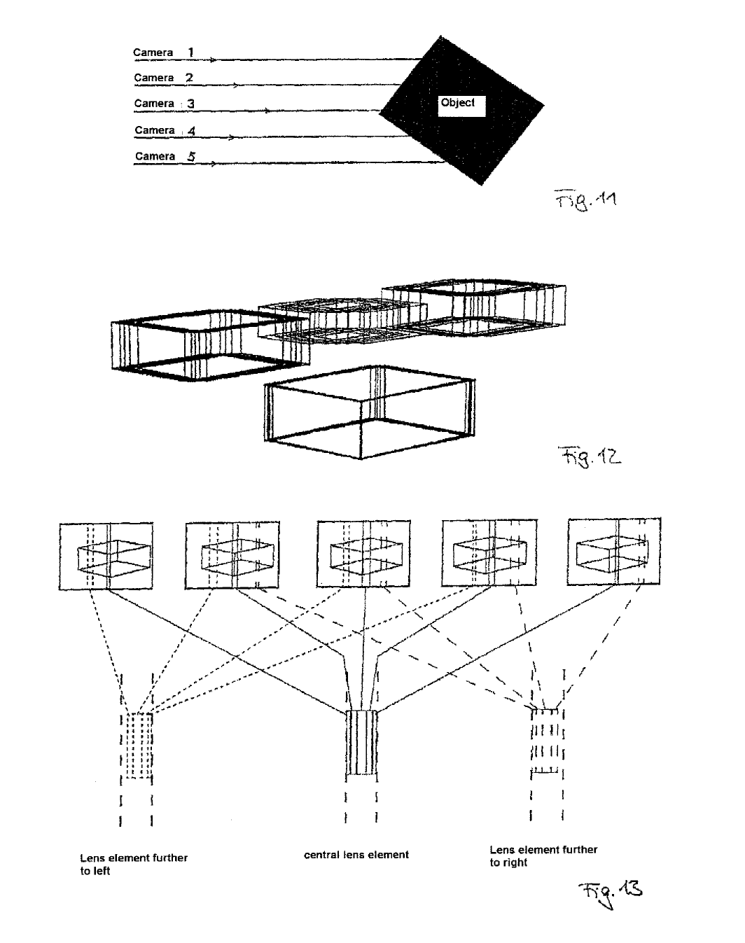

FIG. 10 shows an illustration of the imaging exposure on the base of the lens of a lens element in the form of a diagram. By way of example, the figure shows the imaging behaviour for an animation lens with 10 lpi. The path of the external light beams at the lens corners for a continuous change in viewing angle is shown. It follows that: the more closely the viewing angle approaches a critical angle, the smaller is the extent of the available imaging region, that is, of the visible image pixels. For a negative viewing angle the same result applies. The possible visible pixels at a printing resolution of 600 dpi are given at the side.

FIG. 10 describes the results of a beam trace starting from an observation point and passing through the animation lens, as far as the base of the lens. Preferably, the observation position used for the calculation is that which corresponds to the subsequent actual observation position of a person. The beam construction can be performed for example using light beams to the outer edges of the individual lens. According to the light refraction at these points the region at the base of the lens, which can be seen by the observer at the lens surface, is given. This region is given as a ratio to the overall width of the individual lens and is removed in the diagram.

Since the position and size of the imaging region are dependent on the viewing angle, the observation position is then displaced in steps parallel to the lenticular screen sheet, i.e. laterally, in the diagram according to FIG. 10 by 0.1°. The diagram shown with the angle-dependent imaging exposure at the base of the lens is thus produced gradually. In the present calculation a 0° viewing angle corresponds to an observation position exactly opposite the centre of the lens.

On account of the optical properties of the lens it can also be useful in creating the diagram to consider not only the light beams at the outer ends of the lens curvature, but also to scan the entire lens surface step by step as seen from the observation position. Due to the spherical aberration the light beams at the outermost ends of the lens curvature do not necessarily indicate the largest possible imaging area. Light beams which are localised further towards the centre of the lens can by comparison, especially at higher viewing angles, show larger regions at the base of the lens. The diagram would therefore change appropriately.

A stepwise change in the viewing angles is also conceivable. If it is assumed that when viewed perpendicularly (viewing angle 0°) for example 20 percent of the lens base is clear, the next viewing angle to be considered is that which makes the neighbouring imaging region visible.

At this viewing angle the imaging region is then smaller than the first, e.g., 15 percent. This is continued until the whole lens width of the individual lens has been covered. This would result in a diagram with few points. These could however be translated directly into strip widths (20, 15, . . . percent) and, it is assumed, the number of points represents the optimal number of half images to be processed for this lenticular screen.

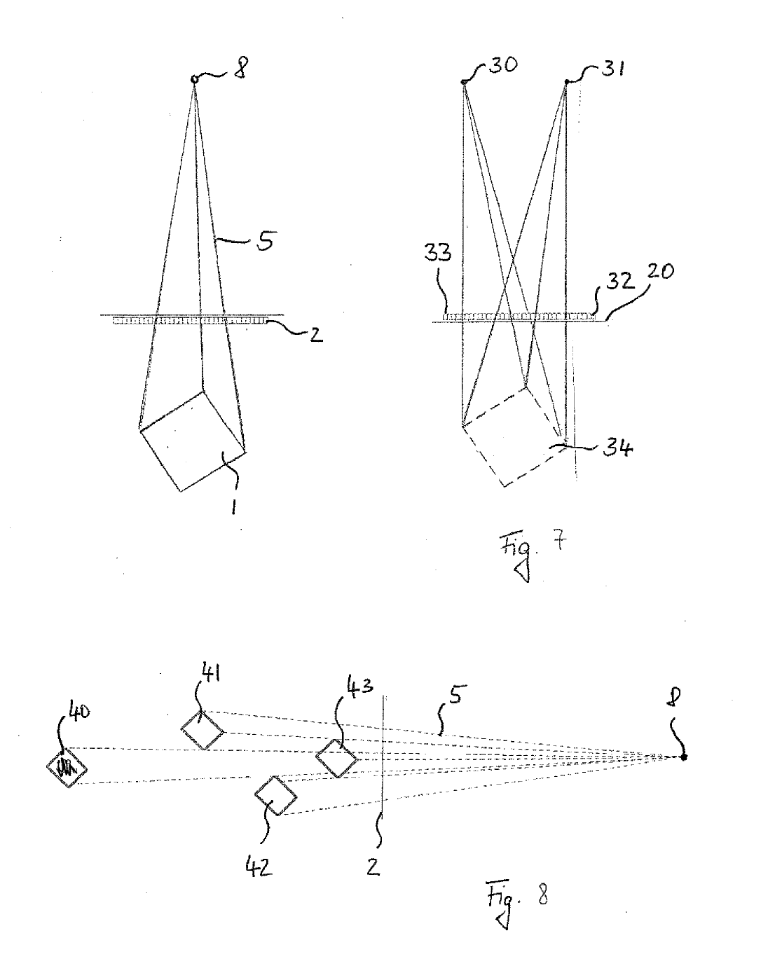

FIG. 5 shows a schematic illustration of an optical imaging system for explaining the VLR method for producing a lenticular screen base image.

The optical imaging system comprises an object 1, which is to be imaged. Opposite to the object 1 a planar lens arrangement 2 is arranged with multiple lens elements 2a in the form of a lenticular screen, wherein curved surfaces 3 are formed on a side facing the object 1 and flat surfaces 4 on a side facing away from the object 1. Using construction beams 5 and considering the optical properties of the planar lens arrangement 2, in particular the beam refraction at the boundary surfaces, multiple object images 6a, 6b of the object 1 arise in an image plane 7. Arranged downstream of the planar lens arrangement 2 is a camera 8. With the aid of the radiation image design shown, a recorded image (parallax panoramagram) of the multiple object images 6a, 6b in the image plane 7 is generated in the camera 8, which image can in other embodiments also be formed nearer to or further away from the curved surface 3. The image data generated in this way for the recorded image (parallax panoramagram) represent a kind of base image for creating the lenticular image. They can subsequently be used to output the base image on a display or to print it on to photographic paper. The described method, which can also be referred to as the VLR method, is expediently embodied by means of a suitable software application, which is implemented so that is can run on a data processing device. The optical imaging system is formed virtually using the application and used to create the radiation image design. Software applications, with which such a radiation image design corresponding to the physical parameters of an optical image in a given imaging system can be embodied, are available as such in different designs, and for this reason they will not be discussed further here. The image data of the parallax panoramagram then exist ultimately as electronic data, which can be passed to a further processing stage, for example outputting via a display or processing in a printer.

FIG. 6 shows a view on to the image plane 7 with the multiple object images 6a, 6b.

FIG. 7 shows a schematic illustration for comparing the method for producing a lenticular screen base image (parallax panoramagram) with the observation of the generated lenticular image with the human visual apparatus, On the left-hand side the situation of FIG. 5 is essentially illustrated again. The same reference labels as in FIG. 5 are used for equivalent features. The right-hand side in FIG. 7 now illustrates the situation when observing the generated lenticular screen base image 20 (cf. 2) with human eyes 30, 31 through a planar, transparent, optically active components 32, embodied as a lenticular screen sheet. It follows that when observing the lenticular screen base image 20 with the human visual apparatus, curved surfaces 33 of the lenticular screen sheet now face towards the human eyes 30, 31. During the observation a 3D spatial impression of a virtual object 34 is produced.

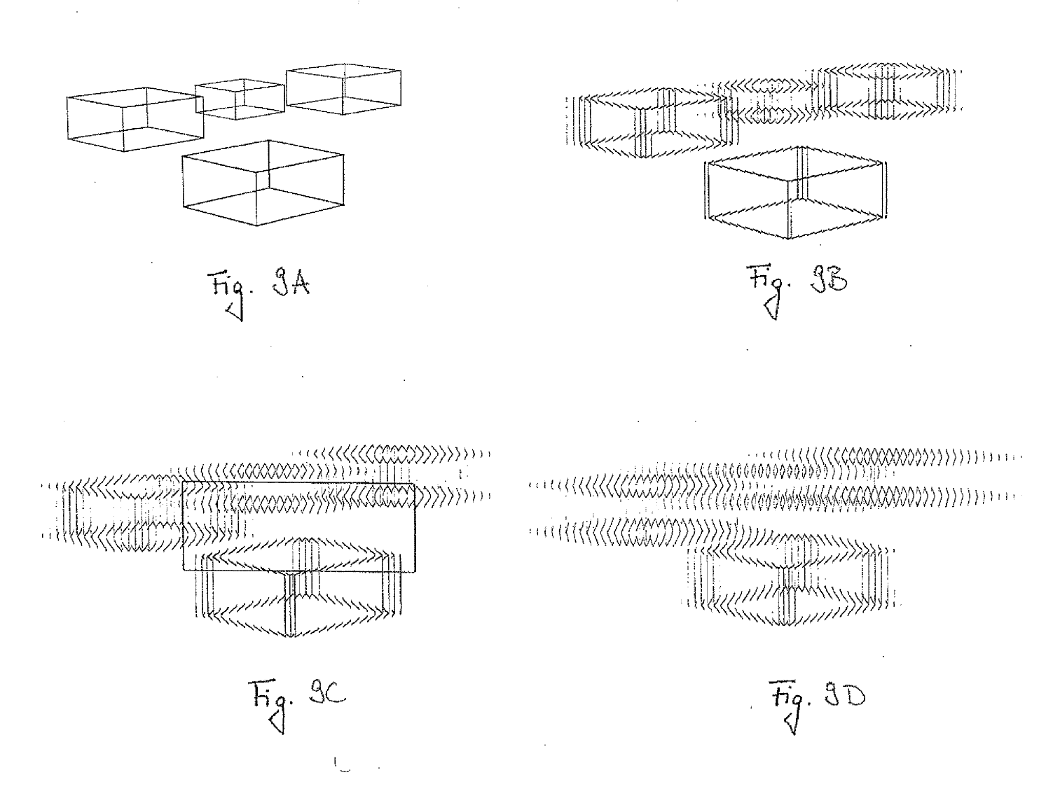

FIG. 8 shows a schematic illustration of an optical imaging system generating a lenticular image of four cubes 40, . . . , 43.

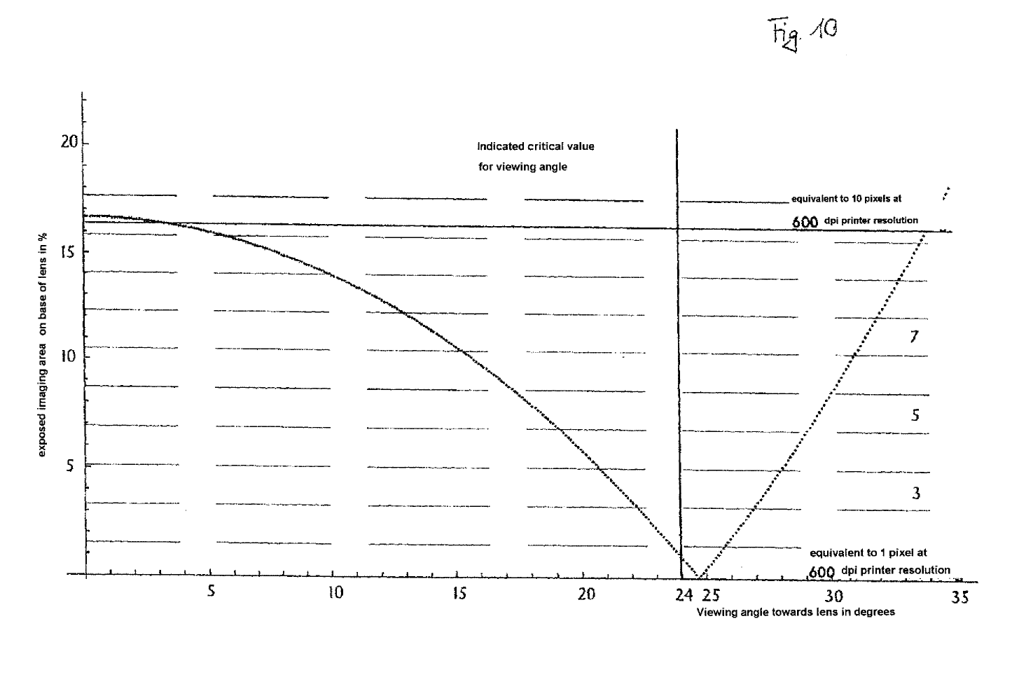

FIG. 9A to show image displays which were generated by radiation image design for the four cubes 40, . . . , 43 from FIG. 8 without a planar lens arrangement (FIG. 9A) and with planar lens arrangement, using refractive indices of 0.97 (FIG. 9B), 0.93 (FIG. 9C) and 0.87 (FIG. 9D). On observing FIG. 9B to 9C through a lenticular screen sheet the 3D image impression occurs at different manifestations of depth.

In the following, embodiments using an interlace method will be described. The interlace method is known as such. For example, reference is made to the description in Bourke, “Autostereoscopic Lenticular Images” (http://local.wasp.uwa.edu.au/˜pbourke/projection/lenticular/), December 1999.

Below, a method for producing a parallax panoramagram using the interlace method will be described by reference to FIGS. 11 to 13, wherein in the interlace method described here strip elements of differing width are interlaced together.

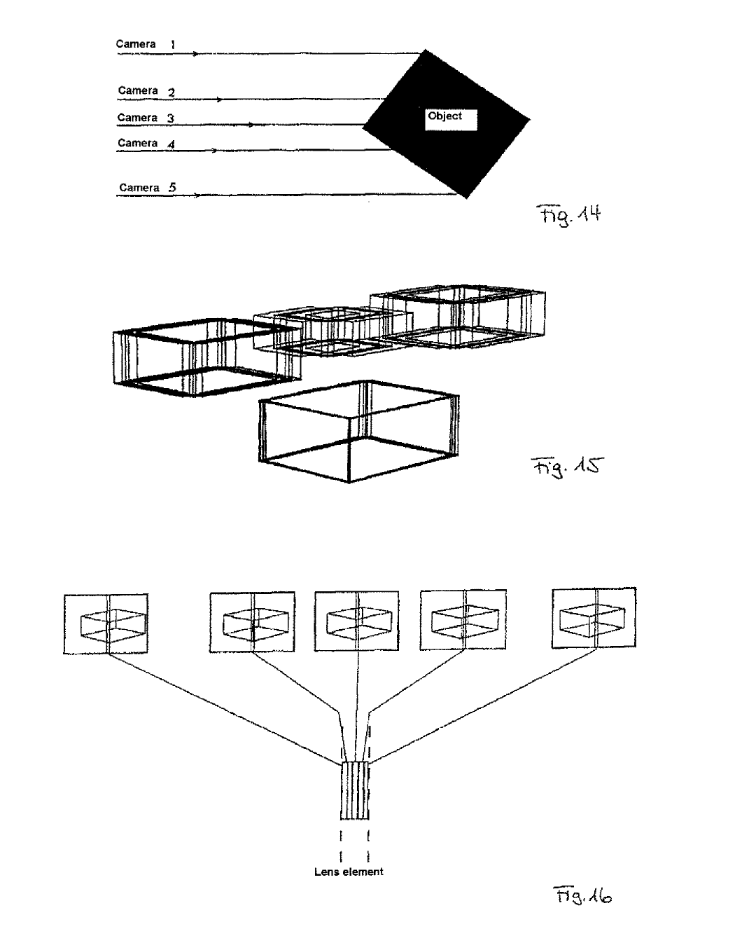

In the method, stereo image recordings of the object to be imaged are first generated in the conventional manner by means of a recording device, in particular a camera, or virtually, namely by means of a software application installed on a computer, which is suitable for image construction. The intervals between recording positions, in which the recording device is arranged either actually or virtually, are selected to be equidistant (cf. FIG. 11). In this manner a sequence of individual half images of the object are generated. The individual half images are adjusted relatively to each other. An independently chosen reference point determines the spatial position of the imaged objects in the subsequent lenticular screen image (cf. FIG. 12).

Following this the individual half images are interlaced in accordance with their position relative to the lens elements (cf. FIG. 13) and to the entire lenticular image with different percentage widths. An adaptation to the lenticular screen used for the parallax panoramagram is thus obtained. FIG. 10 can be drawn upon to assist here: depending on the number of half images the optimal, percentage portion of each strip in terms of the revealed image area on the base of the lens and its position are determined. Essentially the result is a widening in the central lens region and a narrowing at the edge of the lens relative to a uniform strip partition. Due to this adapted strip variation the image contents are better adapted to the imaging behaviour of the lenses, which therefore increases the quality of the image. With the number of half images equal to ten an individual strip width of approximately 1.1%; 6.3%; 11.1%; 14.2%; 17.3%; 17.3%; 14.2%; 11.1%; 6.3%; 1.1% per width of a lens elements would result. This partitioning does not yet take into account the fact that animation lenses in the range of the viewing angles given cannot free the entire base of the lens (cf. FIG. 3). Such a modification can also be useful.

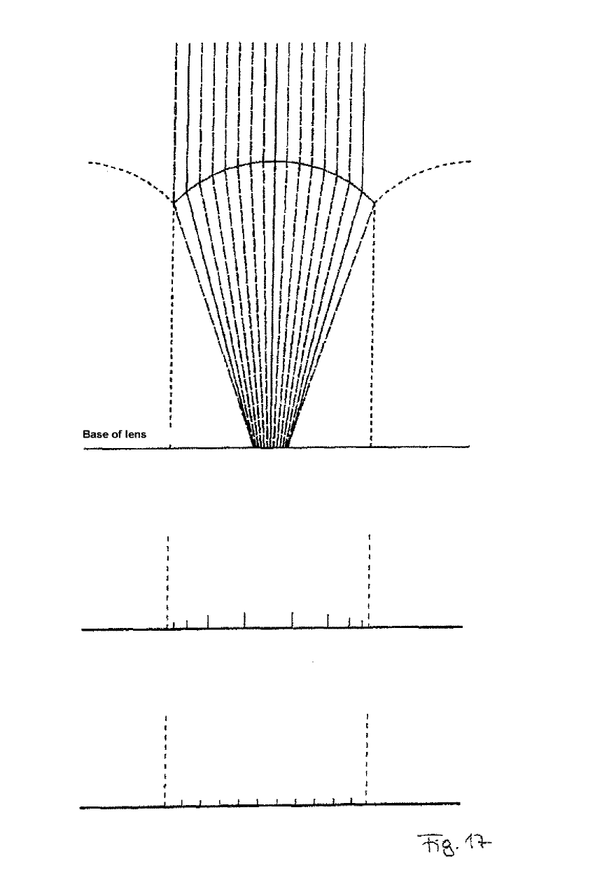

In the following, by reference to FIGS. 14 to 16 an embodiment of a method for producing a parallax panoramagram using the interlace method is explained, wherein the distances between the individual recording positions of the recording device (camera) when generating the individual half images of the object to be displayed are not equidistant at least in part.

As part of the interlace method individual half images of the object to be imaged are first generated, either actually or virtually, by placing the recording device at different recording positions. The selection of the recording positions is performed in accordance with the transparent, optically active component used for the parallax panoramagram, for example a lenticular screen. The optimised distribution of the recording positions has a form that is inversely proportional to the imaging width under the individual lens (FIG. 2-3). In the exemplary embodiment illustrated in FIG. 14, for the lens shape shown (FIG. 1) the recording positions are bunched towards the centre. The individual half images generated are then in appropriately adjusted in the standard manner, which produces an image according to FIG. 15. Following this the individual half images of the interlace method are correspondingly interlaced together (cf. FIG. 16).

FIG. 10 can also be applied for the optimised positioning of the recording units. Here again the example of 10 half images, corresponding to 10 recording positions, can be used. The percentage partitioning, which was previously translated into strip widths, is now converted into recording intervals. Here also the information content of the parallax panoramagram must be increased in the central region of the lens base of each lens element and reduced in the edge regions. With identical strip widths this can only be implemented using the image similarity of the individual half images. The half images for the central strips must be more similar in terms of content, and therefore the recording units are placed closer together than at the edge. The overall recording basis of all cameras does not normally change here relative to the conventional approach. With an overall basis of ten centimetres and ten half images the resulting distances are approximately 17.3 mm; 14.2 mm; 11.1 mm; 6.3 mm; 1.1 mm; 1.1 mm; 6.3 mm; 11.1 mm; 14.2 mm; 17.3 mm. Here also the partitioning does not take into account the fact that within the viewing limits an animation lens cannot usefully optically expose the entire base of the lens. Such an adaptation can be helpful.

The described methods can be used with lenticular screens in which the individual lenses are also different in their shape and dimensions to the shapes shown in the exemplary embodiments. After investigation of the imaging behaviour of other lens shapes or surface characteristics, all the methods described here can be modified accordingly.

This would change FIG. 10 accordingly. Depending on the number of half images used, the percentage figures to be read off change accordingly up to the critical angle. The diagrammed range of 0 to the critical viewing angle is then to be split into equal (half of the half images used) sections. As a basis for this FIG. 10 should be applied and the number of half images to be used must be known. Without FIG. 10 or its equivalent for other surface forms of a transparent, optically active component, only an estimate of the required strip width, or camera intervals, is possible. This should follow the principle that at the centre, half-image strips located under the individual element must be wider, while those at the side should be narrower than in the conventional application of the interlace methods. FIG. 10 was derived numerically from the surface form of an individual lens of a lenticular screen.

In order to determine the strip width, the number of half images for the calculation should be halved, as FIG. 10 shows only the imaging behaviour for positive changes in the observation angle. In the opposite viewing direction the corresponding form applies, mirror-inverted with respect to the Y-axis.

Then, based on the previously determined relevant number of half images, the range of the viewing angle is sub-divided equally between zero and the given critical angle. The percentage figures for the imaging exposure at the base of the lens that can then be read off can be interpreted as a ratio of the individual half-image strips to each other. Using an example of ten half images, in FIG. 10 a total of five equal divisions are made and the corresponding proportions removed. In the example approx. 16.3 to 13.3 to 10.4 to 5.9 to 1. From this a percentage strip width of approx. 17.3%; 14.2%; 11.1%; 6.3%; 1.1% can be derived (proportion related to 50 percent of the lens base). This applies in the same way to the second half of the lens base.

In the example, this results in a half-image strip width for the ten half images used of approx. 1.1%; 6.3%; 11.1%; 14.2%; 17.3%; 17.3%; 14.2%; 11.1%; 6.3%; 1.1%. This partitioning does not yet take into account the fact that animation lenses in the range of the viewing angles given cannot free the entire base of the lens (cf. FIG. 3). Such a modification can also be useful.

The half-image strips must then be converted into pixel widths based on the width of the lens and printer resolution and then the rounded values used. If, for example, exactly 60 pixels are interlaced under one lens element (for an animation lens with 10 lpi equivalent to a printer resolution of 600 dpi) the pixel widths of the half-image strips in the example are to be divided up approximately as follows: 1; 4; 7; 8; 10; 10; 8; 7; 4; 1. It can also be useful to retrospectively convert the individual half-image strips from the conventionally calculated strips of the interlace method (in the example a constant 6 pixels wide) into the suggested pixel widths, and then compress them or stretch them in width. Even the position of the individual lens element to the left or right in the lenticular screen sheet can affect the sequence of the interlaced half images. Thus a further deformation of these modified half-image strips can comprise the fact that in the right-hand region of the, for example, lenticular screen image the half images recorded further to the right are placed in the middle and those to the left correspondingly placed to the left (cf. FIG. 13).

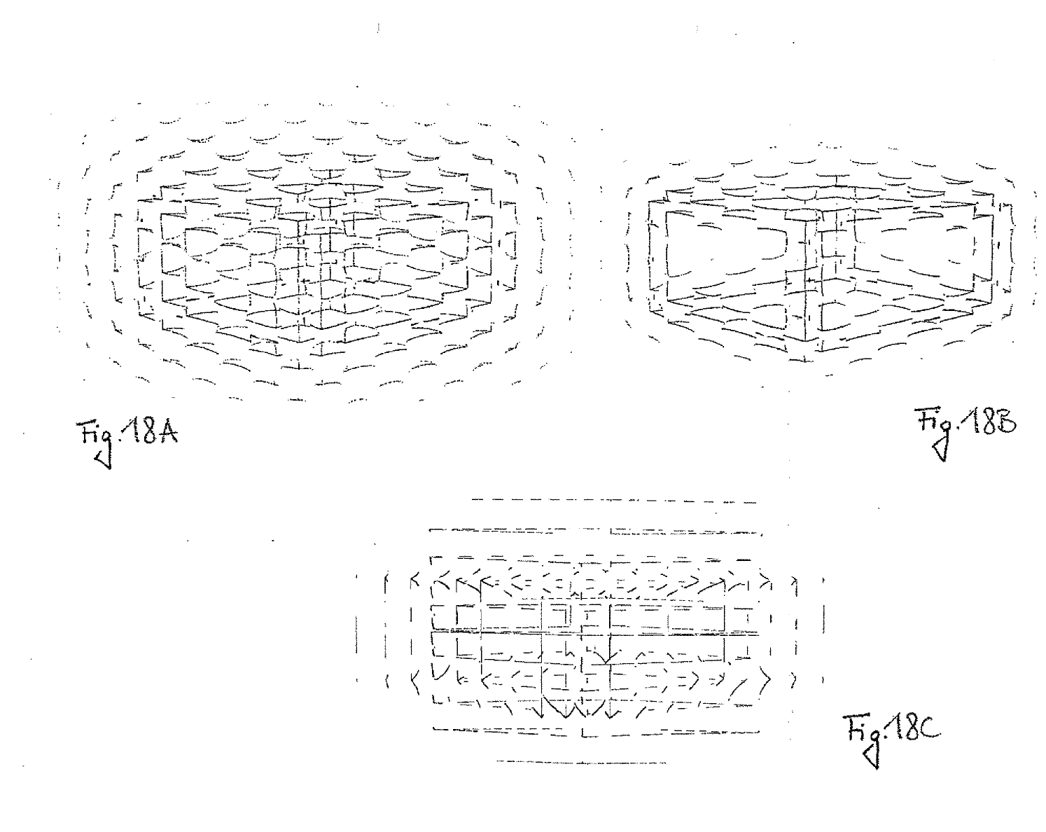

In order to calculation the non-equidistant camera intervals it is necessary to proceed, as just described, with the aid of FIG. 10. However, the percentage strip width (number of cameras corresponds here to the number of half images) is applied in reverse to the camera intervals. Overall the information content of the parallax panoramagram must be increased here also in the central region of the lens base of each lens element and reduced in the edge regions. With identical strip widths this can only be implemented using the image similarity of the individual half images. The half images for the central strips must be more similar in tei ins of content, and therefore the recording units are placed closer together than at the edge. The overall recording basis of all cameras does not normally change here relative to the conventional approach. With an overall basis of ten centimetres and ten half images, distances result of approximately 17.3 mm; 14.2 mm; 11.1 mm; 6.3 mm; 1.1 mm; 1.1 mm; 6.3 mm; 11.1 mm; 14.2 mm; 17.3 mm. Here also the partitioning does not take into account the fact that within the viewing limits an animation lens cannot usefully optically expose the entire base of the lens. Such an adaptation can be helpful. The VLR method comprises the adaptation to the imaging behaviour of the lens right in its basic principle, due to the virtually created counterpart of the transparent, optically active component that is actually placed upstream. By way of conclusion and summary, FIG. 17 illustrates this for all methods.

In particular in the methods presented that build on the interlace method, an advantageous characteristic consists in the fact that not all of the available half images per lens element are used. This depends on the position underneath the lenticular screen sheet. Although for example 10 half images are available, it can be useful to process only 7 for an individual lens. This is given as a specific supplement to the methods presented with variable strip width and non-equidistant camera positions.

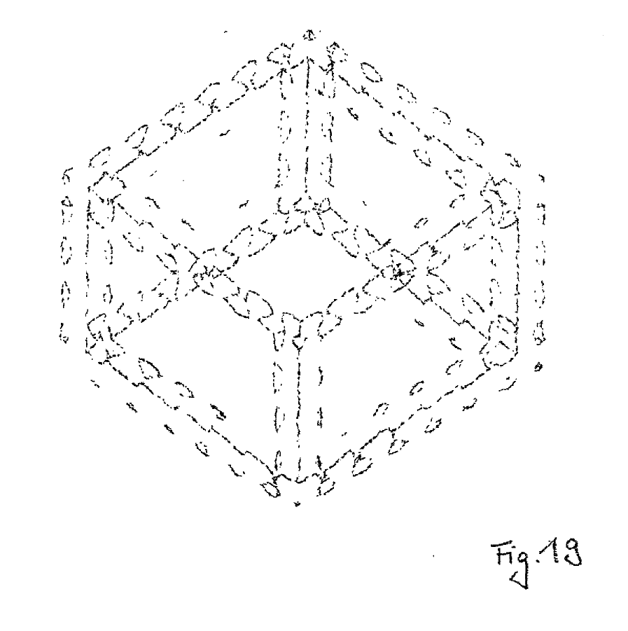

FIG. 18A to 18C show various parallax panoramagrams, which were generated using circular lens elements (fly's eye) (FIG. 18A, 18B) and using a lenticular screen, in which the individual lens elements has been produced from the superposition of two intersecting conventional semi-lenticular screen sheets (FIG. 18C). FIG. 18A was created with a refractive index of 0.9, and FIGS. 18B and 18C with n=0.95. The resulting base images, in interaction with the corresponding imaging elements, produce a so-called integral image, which in contrast to the conventional 3D images can also be viewed equally well and in 3 dimensions from different vertical viewing angles (half lenses enable the representation of 3D images due to their being aligned only in the horizontal plane). In this example an apparently 3D cube is visible, which shows an excerpt from FIG. 8.

FIG. 19 shows a parallax panoramagram, which was produced on the basis of a shaped glass plate. To this end, the shaped glass (similar to a fly's eye) was scanned in 3D and the surface structure obtained used to generate the base image. An object image is formed, which is specifically matched to the more or less irregular surface of the shaped glass. If the original glass plate is placed in front of the base image, the cube is optically and three-dimensionally “reconstructed”. Depending on the structure (sheet thickness, lens shape) and quality (trapped air, evenness of the glass base etc.) of the shaped glass, the three-dimensional reconstruction and imaging quality can be perceived with appropriate clarity.

The features of the invention disclosed in the present description, claims and the drawings can be of significance both individually and in any desired combination for the implementation of the invention in its various embodiments.

1. A method for producing an autostereoscopic display, which shows at least one object, comprising:
imaging, by a data processing device, an object as an object image in an image plane, the object being disposed opposite an imaging lens associated with a virtual optical imaging system, recording the object image in the image plane, and producing image data for a parallax panoramagram of the object image in the recording device,
producing, by the data processing device, an image corresponding to the image data for the parallax panoramagram, and
producing, by the data processing device, an autostereoscopic display by disposing a transparent planar arrangement of imaging elements that corresponds to the imaging lens upstream of the parallax panoramagram.

2. The method according to claim 1, wherein the autostereoscopic display is generated by displaying the image data for the parallax panoramagram via a display area and the arrangement of imaging elements upstream of the imaging lens is displayed on the display area in the form of an electronically simulated arrangement of imaging elements.

3. The method according to claim 1, wherein the autostereoscopic display is generated by generating the image corresponding to the image data for the parallax panoramagram on a carrier material on an imaging side and a transparent component with the arrangement of imaging elements is arranged upstream of the imaging side.

4. The method according to claim 3, wherein the parallax panoramagram is printed on the carrier material.

5. The method according to claim 3, wherein the transparent component is adhesively disposed on the imaging side.

6. The method according to claim 1, wherein generating the image data for the object image comprises generating the image data for the object image when a radiation image design in the virtual imaging system is designed so as to use a refractive index that is not equal to 1.

7. The method according to claim 1, wherein lenses of the arrangement of imaging elements are shaped such that on a side facing away from the image they comprise a curved surface, and on a side facing the image side an essentially flat surface.

8. The method according to claim 1, wherein autostereoscopic display data are stored on an electronic storage medium, which data comprise the image data for the parallax panoramagram and information about parameters for the imaging lens.

9. An system for an autostereoscopic display, in which an image corresponding to image data of a parallax panoramagram for an object image is applied on an imaging side of a carrier material and a transparent component is arranged upstream of the imaging side with a transparent planar arrangement of imaging elements, corresponding to an imaging lens, wherein by means of a data processing device for at least one object in association with a radiation image design in a virtual optical imaging system, which comprises the at least one object, and wherein the imaging lens is disposed opposite the at least one object and images said object as an object image in an image plane, and a recording device recording the object image in the image plane, the image data are generated for a parallax panoramagram of the object image in the recording device.

10. Electronic storage medium with a storage area, which is configured to store electronic data, wherein autostereoscopic display data generated according to a method as specified in claim 1 are stored in the storage area.

11. A method for producing an autostereoscopic display, which shows at least one object, comprising:
interlacing image strips together using interlace method comprising strips of differing widths.

12. The method according to claim 11, wherein the differing width of the interlaced strips is formed in proportion to a respective imaging width of individual lenses of a transparent, optical imaging lens used in the interlace method.

13. A method for producing an autostereoscopic display, which shows at least one object, comprising:
generating images of the at least one object using an interlace method, wherein distances between recording positions for a recording device comprise differing, non-equidistant intervals.

14. The method according to claim 13, wherein the non-equidistant intervals are inversely proportional to a respective imaging width of individual lenses of a transparent, optical imaging lens used in the interlace method.
